(19) United States
(12) Patent Application Publication
(10) Pub. No.: US 2007/0188097 A1
(43) Pub. Date: Aug. 16, 2007

(54) Phosphor layer and plasma display panel using the same

(75) Inventors: Dong Oh Shin, Gyeonggi-do (KR); Dae Hyun Park, Gyeonggi-do (KR); Bum Jin Bae, Gyeonggi-do (KR); Kyung Ku Kim, Gyeonggi-do (KR); Nam Seok Kang, Gyeonggi-do (KR); Byung Gil Ryu, Seoul (KR); Je Seok Kim, Gyeonggi-do (KR); Hong Cheol Lee, Gyeonggi-do (KR); Byung Hwa Seo, Seoul (KR); Won Seok Jeon, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/657,446

(22) Filed: Jan. 25, 2007

(30) Foreign Application Priority Data
Jan. 25, 2006 (KR) 10-2006-0007702

(51) Int. Cl. H01J 17/49

(52) U.S. Cl. 313/582

(57) ABSTRACT

A phosphor layer to improve the light emitting efficiency and color purity and a plasma display panel using the same are provided. According to an embodiment, the phosphor layer includes a phosphor to be excited by a discharge gas and to emit light of a specific color, and a photonic crystal and having a photonic band gap.

This application claims the priority benefit of Korean Patent Application No. 10-2006-0007702, filed on Jan. 25, 2006, which is hereby incorporated by reference as if fully set forth herein.

### BACKGROUND OF THE INVENTION

1. Field of the Invention

The present invention relates to a plasma display panel, and more particularly, to a phosphor layer to improve light emitting efficiency and color purity using phosphor containing a photonic crystal and to a plasma display panel using the same.

2. Discussion of the Related Art

A plasma display panel (hereinafter, referred to as a ‘PDP’) is a kind of a light emitting device to display an image using a charge phenomenon. Since it does not need to install active devices to every cell of the PDP, the manufacturing process of the PDP can be simply implemented. Moreover, since a screen size can be easily increased and a response speed is high, the PDP is spotlighted as a display device of an image displaying apparatus having a big screen.

Such a PDP, as illustrated in FIG. 1, generally has a structure of an upper panel 10 facing a lower panel to be overlapped with each other. The upper panel 10 includes a pair of sustain electrodes 12 arranged on an inner surface of a transparent substrate 11. In general, the sustain electrode 12 is divided into a transparent electrode and a bus electrode.

The sustain electrodes are coated with a dielectric layer 13 for alternating current (AC) drive and a surface of the dielectric layer 13 is formed with a protecting layer 15.

On the other hand, on the inner surface of the upper panel 20, address electrodes 22 are arranged on a lower substrate 21 and a dielectric layer 23 is formed thereon. On this dielectric layer 23, stripe-type or well-type barrier ribs 24 to partition a space into discharge cells are formed such that the discharge cells partitioned by the barrier ribs 24 are coated with red, blue, and green phosphor layers 26 to form sub-pixels.

Due to the barrier rib 24, the discharge cells 25 are partitioned by the sub-pixels and are filled with discharge gas, and a single pixel includes the three color sub-pixels.

Phosphor applied to the general phosphor layer 26 coated to the discharge cells 25 exists in the form of granule, and absorbs vacuum ultraviolet rays generated by the discharge and transited to emit red, blue, and green light, respectively.

Type of phosphor employed in the PDP is restricted according to the related art. In other words, there are some materials used in the PDP such as (Y, Gd)BO₃:Eu, YBO₃:Eu, Y₂O₃:Eu applied to red, An₂SiO₄:Mn, BaAl₁₂O₁₉:Mn applied to green, and BaMgAl₁₀O₁₇ applied to blue.

Thus, in order to increase the luminous efficiency using the conventional materials, various attempts to adjust the size of granule, to adjust crystallinity, to add a new substance, and to develop a new substance are conducted.

However, it is difficult to control the inherit luminous properties of the phosphor materials and there are many restrictions and limitations associated with the cost and process. As a result, these attempts are not successful.

### SUMMARY OF THE INVENTION

Accordingly, the present invention is directed to a phosphor layer and a plasma display panel using the same that substantially obviate one or more problems due to limitations and disadvantages of the related art.

An object of the present invention is to provide a phosphor layer in which phosphor including a granule having a photonic crystal property is used such that the luminous efficiency of the phosphor is increased and the purity of colors of lights emitted there from is increased.

Another object of the present invention is to provide a plasma display panel using phosphor to emit red, green, and blue light and including a phosphor layer in which photonic crystals having a photonic band gap of a specific wavelength band are mixed.

To achieve these objects and other advantages and in accordance with the purpose of the invention, as embodied and broadly described herein, a phosphor layer of a display device according to an aspect of the present invention comprises: a phosphor to be excited by a discharge gas and to emit light of a specific color; and a photonic crystal mixed with the phosphor and having a photonic band gap.

In another aspect of the present invention, a phosphor layer of a display device comprises: phosphor powder excited by an ultraviolet ray to emit light; and a photonic crystal mixed with the phosphor powder and having a photonic band gap.

In still another aspect of the present invention, a plasma display panel comprises a phosphor layer formed in a discharge space of the plasma display panel and including a photonic crystal having a photonic band gap.

In still another aspect of the present invention, a plasma display panel comprises a phosphor layer formed in a discharge space of the plasma display panel and including a plurality of photonic crystal particles.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating an example of a plasma display panel according to a related art;

FIG. 2 is a graph illustrating an example of an energy band of a general photon;

FIG. 3 is a graph illustrating an example of an energy band of a photon having a band gap;

FIG. 4 is a view illustrating a structure of an example of a photonic crystal employed in the present invention;

FIG. 5 is a view illustrating the structure of FIG. 4 in a reciprocal lattice space;

FIG. 6 is a view illustrating various types of photonic crystals and spectrums thereof; and

FIG. 7 is a schematic view illustrating a plasma display panel coated with a phosphor layer according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

In general, a photonic crystal refers to a structure having an optical property or a structure made to have the optical property, and more particularly, to a substance having a grating period similar to a wavelength of light corresponding to a visual light.

In 1991, Eli Yablonovitch group has proved the fact that a photonic band gap corresponding to a band gap of solid substance can exist even in a photon.

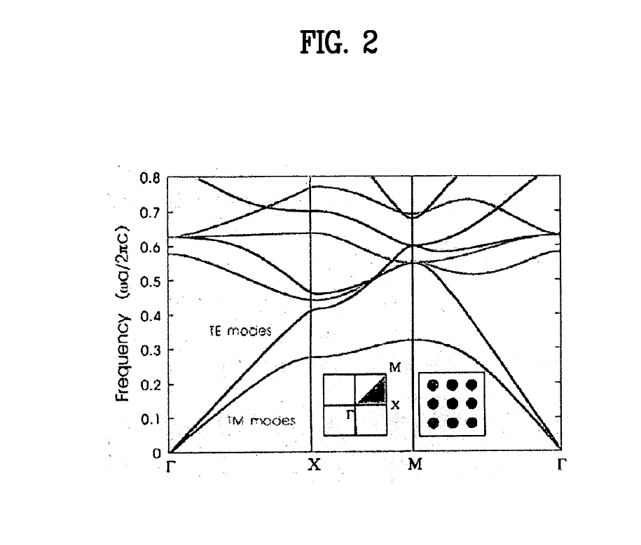

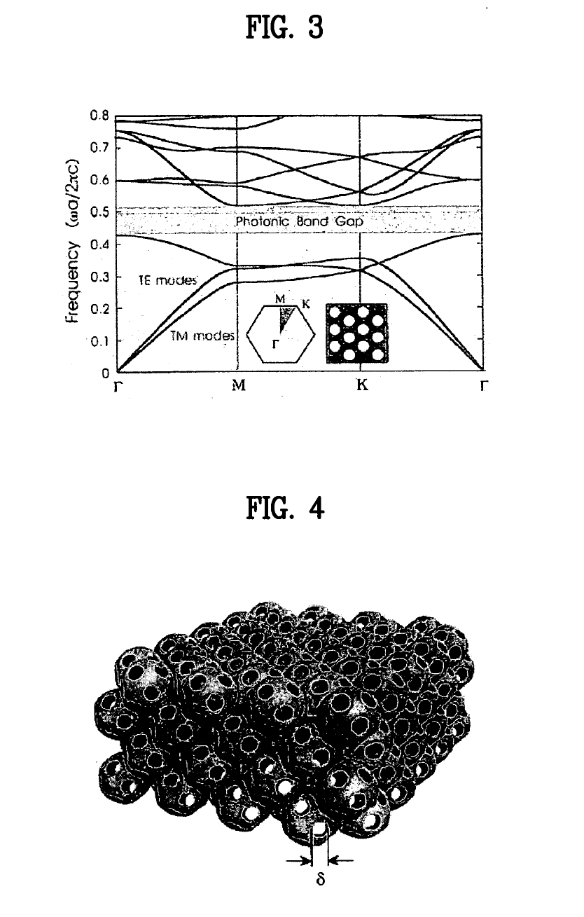

In the same manner that the band structure of the solid substance is dependent upon the lattice structure in the substance, the photonic band gap is also determined by the lattice structure in the substance. This photonic band gap will be described with reference to FIGS. 2 and 3.

FIGS. 2 and 3 illustrate inner crystal structures, wherein the crystals are arranged uniformly in FIG. 2 but are misaligned with each other by one crystal in FIG. 3.

In a case of FIG. 2, graphs are spread out over the entire frequency regions, whereas graphs are not present in a specific frequency region as illustrated in FIG. 3 (photonic band gap region). This means that light having a wavelength of this band can pass.

This photonic band gap is sensitively affected by an arrangement and positions of holes of the lattice substance.

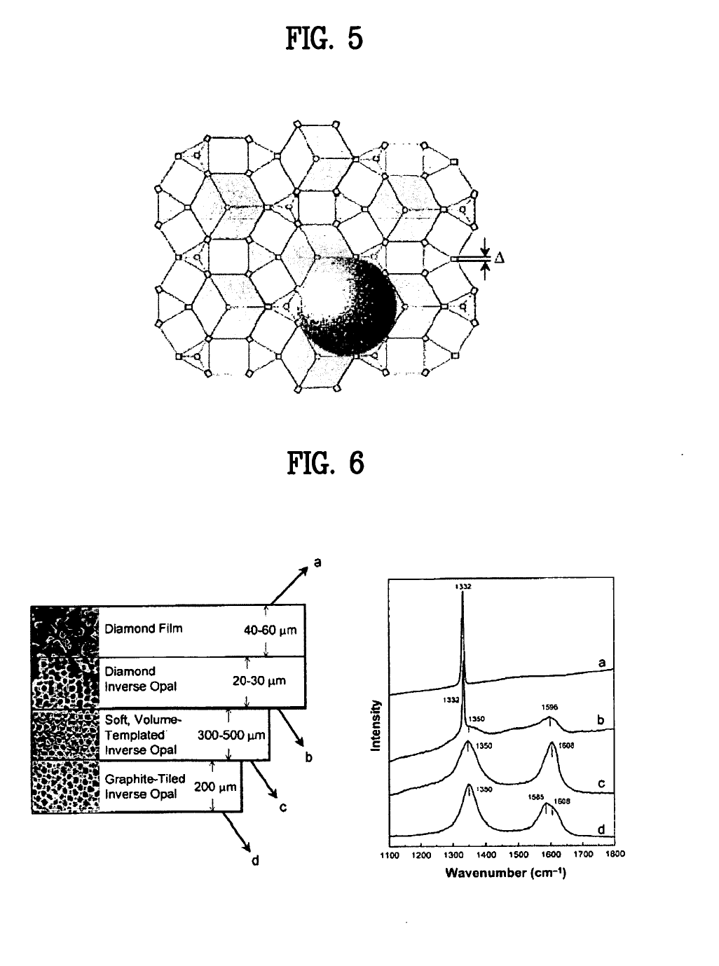

FIG. 4 illustrates a model of an opal structure in which specifically sized (δ) holes are arranged on surfaces of granules to form a lattice. FIG. 5 illustrates a relationship between the opal structure and an inversed opal structure in the structure model. The photonic crystal of the present invention can have the opal or inversed opal structure.

The relationship between FIGS. 4 and 5 is similar to a relationship between an atom-sized lattice and the relationship of a reciprocal lattice with respect to the atom-sized lattice, and can be understood through δ in FIG. 4 and A in FIG. 5.

As such, when the porous granules form a lattice, the band of the photonic band gap wavelength illustrated in FIG. 3 is differed in accordance with a shape of each lattice, a size of the granule, and a size and number of the holes.

As illustrated in FIG. 6, the right-side graph shows a change of optical properties of photonic crystals having various structures and thickness illustrated in the left-side diagram in FIG. 6.

These structures of FIG. 6 can be formed by using a plasma-enhance chemical vapor deposition (CVD), and a spectrum thereof indicates a micro-Raman spectrum. Here in this example, a wavelength of an excitation light is 514.5 nm and a beam diameter is 1 micro-meter.

As illustrated in FIG. 6, the Raman shift is not observed in a diamond film (e.g., the file (a)), but in other structures (e.g., inverse opal films (b)-(d)). This means that a corresponding photonic crystal (e.g., photonic crystals corresponding to the structures (b)-(d)) absorbs, emits, or transmits light.

Therefore, according to the present invention, a photonic crystal having a specific photonic band gap is included in a phosphor layer of a display device, so that the color purity and luminous efficiency of light emitted from the phosphor can be improved. Here, the display device is preferably a PDP, but can be other types of displays according to the present invention.

As the photonic crystal, the diamond film to form the lattice, and various particles such as carbon particle (e.g., graphite, porous silica (SiO₂), etc.) and the like can be used in addition to the several structures illustrated in FIG. 6.

Since three primary colors such as red, green, and blue are used in the conventional displays, it is preferred to use a photonic crystal having the photonic band gap corresponding to the three primary colors.

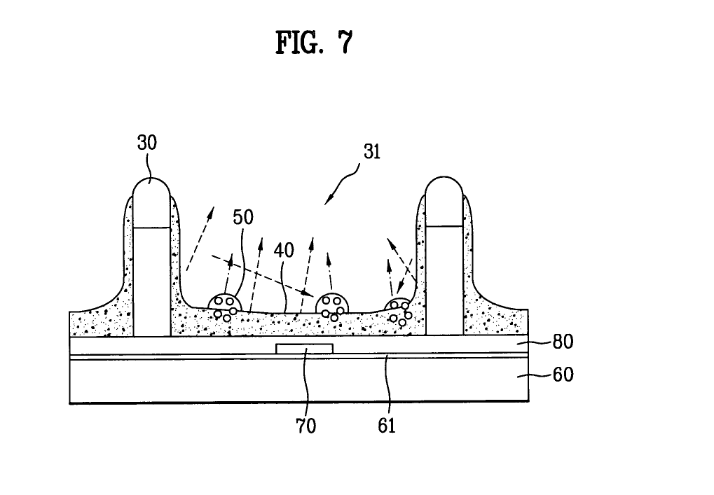

FIG. 7 illustrates a structure of a plasma display panel (PDP) in which a photonic crystal 50 is included in a phosphor layer 40 according to an embodiment of the present invention.

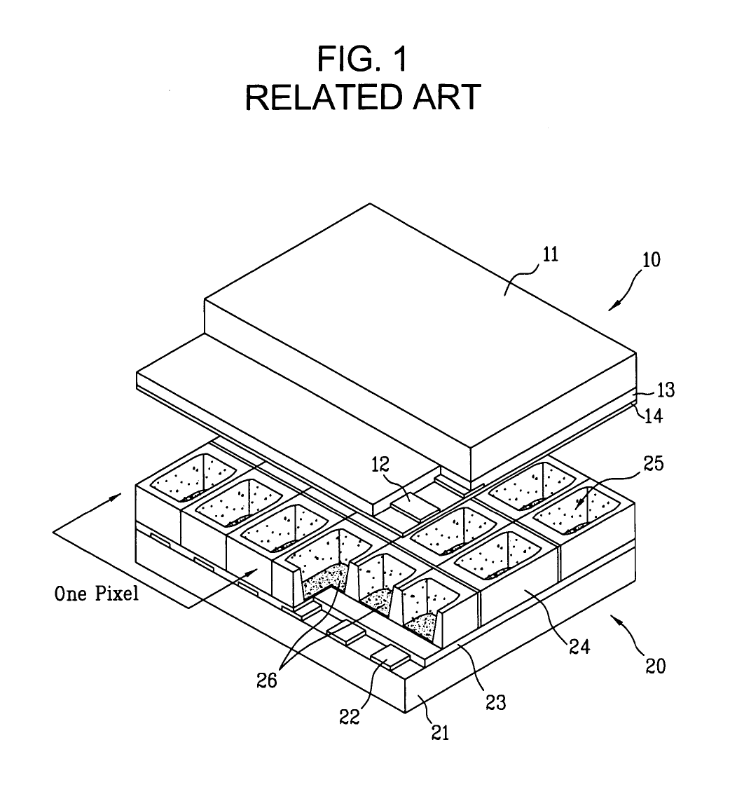

As illustrated in FIG. 7, the plasma display panel includes an under layer 61 formed on a lower substrate 60, an address electrode 70 provided on the under layer 61 but at the lower side of a discharge cell space 31, and a dielectric layer 80 formed on the address electrode 70. The elements shown in FIG. 7 are preferably, but not necessarily, provided as part of a lower panel of the plasma display panel. The plasma display panel includes the lower panel and an upper panel separated by barrier ribs 30. The upper panel here can be the same structure as the upper panel 10 of FIG. 1, but can be have different structures.

The phosphor layer 40 includes phosphor and the photonic crystal(s) 50, and is coated in the discharge cell space 31 defined by the barrier ribs 30 that are formed on the dielectric layer 80.

In FIG. 7, according to an embodiment, the size and position of the photonic crystals 50 may vary. For instance, different from the case of FIG. 7, smaller-sized photonic crystals 50 may be used and mixed with the phosphor of the phosphor layer 40, homogeneously or not.

In this case, the photonic band gap of the photonic crystals 50 contained in the phosphor layer 40 of the discharge cell space 31 will be matched to the colors (e.g., red, green, blue) of the corresponding discharge cells 31.

For example, in a case of a red discharge cell space 31, a photonic crystal 50 having a photonic band gap with a wavelength corresponding to red may be included in the portion of the phosphor layer 40 that is coated on the red discharge cell space 31. The same can be applied to green and blue discharge cell spaces.

According to an embodiment of the present invention, the structure of the photonic crystal 50 having a specific photonic band gap and the size of the holes may be determined by experiments, preferably, by using a computer simulation. One of the methods that uses the computer simulations can use a finite difference time domain, but other various methods may be used.

In general, light emitted from the phosphor of the coated phosphor layer 40 has a spectrum of a relative wide width. When the photonic crystal 50 absorbs light corresponding to the photonic band gap, the photonic crystal 50 absorbs light having an energy higher than the photonic band gap to emit light corresponding to the corresponding photonic band gap.

On the other hand, when the photonic crystal 50 transmits light corresponding to the photonic band gap, the photonic crystal 50 transmits only a desired light so that the color purity can be increased.

Therefore, by including the photonic crystals 50 having the photonic band gaps in the phosphor layer 40 of the PDP according to the present invention, the intensity of color that is easily lost is effectively increased so that the phosphor layer 40 can be used to improve the luminous efficiency of the PDP. Moreover, the photonic band gap of the photonic crystal 50 can be minutely adjusted so that the purity of color can be also adjusted accurately.

Furthermore, when the intensities of light emitted from the respective phosphor layers 40 are different from each other, the intensities can be properly adjusted to have proper white balance.

According to an embodiment of the present invention, this photonic particle is a bulk particle having a lattice structure and can be mixed with the phosphor layer 40 in a state where an external appearance thereof is approximately a spherical shape to be used.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A phosphor layer of a display device, comprising:
a phosphor to be excited by a discharge gas and to emit light of a specific color; and
a photonic crystal mixed with the phosphor and having a photonic band gap.

2. The phosphor layer according to claim 1, wherein the photonic crystal comprises a porous silica particle.

3. The phosphor layer according to claim 1, wherein the photonic crystal comprises a porous carbon particle.

4. The phosphor layer according to claim 1, wherein the photonic band gap corresponds to an energy of a wavelength corresponding to at least one of red, green, and blue color.

5. The phosphor layer according to claim 4, wherein the photonic band gap is adjusted within the energy band of the wavelength.

6. The phosphor layer according to claim 1, wherein the photonic band gap is determined by a particle size of the photonic crystal.

7. The phosphor layer according to claim 1, wherein the photonic crystal comprises a three-dimensional structure.

8. The phosphor layer according to claim 1, wherein the photonic crystal comprises a lattice structure.

9. The phosphor layer according to claim 1, wherein the photonic crystal comprises an inversed opal structure.

10. The phosphor layer of a display according to claim 1, wherein the photonic crystal has a spherical shape.

11. The phosphor layer according to claim 1, wherein the photonic crystal is formed by which a bulk particle having a predetermined size is mixed with phosphor powder.

12. A phosphor layer of a display device, comprising:
phosphor powder to be excited by an ultraviolet ray to emit light; and
a photonic crystal mixed with the phosphor powder and having a photonic band gap.

13. A plasma display panel comprising:
a phosphor layer formed in a discharge space of the plasma display panel, and including a photonic crystal having a photonic band gap.

14. The plasma display panel according to claim 13, wherein the photonic band gap corresponds to a partial wavelength of a band of wavelengths of light emitted from the phosphor layer formed in the discharge space of the plasma display panel.

15. The plasma display panel according to claim 13, wherein the photonic crystal comprises a plurality of porous silica particles.

16. The plasma display panel according to claim 15, wherein the plurality of porous silica particles form a lattice structure.

17. The plasma display panel according to claim 16, wherein the lattice structure is an opal structure or an inversed opal structure.

18. The plasma display panel according to claim 13, wherein the photonic band gap corresponds to an energy of a wavelength corresponding to one of red, green, and blue color.

19. The plasma display panel according to claim 13, wherein the photonic crystal is formed by which a bulk particle having a predetermined size is mixed with phosphor powder.

20. The plasma display panel according to claim 15, wherein the photonic band gap of the photonic crystal matches a band gap of the phosphor layer.

21. A plasma display panel comprising:
a phosphor layer formed in a discharge space of the plasma display panel, and including a plurality of photonic crystal particles.

22. The plasma display panel according to claim 21, wherein the photonic crystal particles comprise either porous silica particles having a lattice structure or carbon particles.

23. The plasma display panel according to claim 21, wherein the photonic band gap corresponds to an energy of a wavelength corresponding to one of red, green, and blue color.

24. The plasma display panel according to claim 21, further comprising:
a barrier rib formed on a lower substrate of the plasma display panel, wherein the phosphor layer is formed on an inner side of the barrier rib.
